(19) United States
(12) Patent Application Publication
(10) Pub. No.: US 2008/0193106 A1
(43) Pub. Date: Aug. 14, 2008

(54) Information Carrier With Improved File Structure, Apparatus And Method For Recording And Playback

(75) Inventor: Wilhelmus Jacobus Van Gestel, Heeze (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,596

(22) PCT Filed: Aug. 26, 2005
(86) PCT No.: PCT/IB05/52808

§ 371 Date: Mar. 2, 2007

(30) Foreign Application Priority Data
Sep. 7, 2004 (EP) 04104308.4

(51) Int. Cl. H04N 7/26

(52) U.S. Cl. 386/124

(57) ABSTRACT

The invention relates to an information carrier which is adapted to record and play back digital video information, wherein the information carrier comprises stream files containing video information and content files containing information relating to the contents of the stream files, and wherein the information required to display a table of contents of the stream files is contained in a single content file. This information carrier allows a rapid presentation of a table of contents of the information carrier because only a single file has to be accessed to read the required information. The invention is particularly but not exclusively applicable to Blu-ray discs. The invention also relates to a recording apparatus adapted to update said file, a playback apparatus adapted to read out said file and methods executed by such apparatuses.

The invention relates to an information carrier, which is adapted to record and playback digital video information, the information carrier comprising stream files containing video information and content files containing information relating to the contents of the stream files.

The invention also relates to a recording apparatus for recording digital video information on an information carrier, the recording apparatus comprising means for recording stream files on the information carrier and to a playback apparatus for playing back digital information from an information carrier, which playback apparatus is adapted to initially read content files from the carrier and to generate a display signal representing the content files after the information carrier has been inserted into the playback apparatus.

The invention also relates to a recording method for recording digital information representing a video signal on an information carrier, the method comprising the step of recording video stream files containing video information on the information carrier, and to a playback method for playing back digital information representing a video signal from an information carrier, the method comprising the step of playing back video stream files from a video carrier.

The invention also relates to a playback method for playing back digital information representing a video signal from an information carrier, the method comprising the steps of playing back video stream files containing video information from a video carrier, reading out content files present on the information carrier and generating a display signal representing the information in the content files.

Information carriers of this type, and apparatuses and methods of the type described above are generally known in the art.

These known apparatuses and methods are adapted to play back and record video information on optical discs. An example of such an optical disc is a DVD, which is an acronym for Digital Versatile Video Disc. The invention is, however, not limited to such DVDs, but is also applicable to optical discs of other formats. The invention may also be applicable to future technologies and formats for optical discs.

DVDs are sold with prerecorded movies, but they are also available as recordable and rewritable discs onto which video signals can be recorded at will. The present invention relates to information carriers of the latter type, i.e. information carriers which are adapted to be recorded at will and to the equipment related thereto which is adapted to record and play back these information carriers. However, the invention is not only applicable to optical discs, but also to information carriers of other formats.

Information carriers of the type to which the present invention relates are used for recording video stream files and content files. Although these files are recorded sequentially, erasing of video stream files and the corresponding content files can lead to ‘gaps’, which can be filled with recordings at a later stage. Consequently, the data of the files may be scattered across the information carriers. The file system used in these information carriers maintains information relating to the location of the data of the files in file system tables.

When such an information carrier is inserted into an apparatus to play back video streams recorded on said information carrier, the apparatus initially reads out the tables of the file system maintaining the location of the different video stream files and content files. After reading out, the apparatus accesses the relevant content files which might be scattered across the information carrier, reads the information relating to the contents of the video streams from the files and generates a display signal for a display unit connected with the apparatus, such that a menu with a Table of Contents (TOC) is displayed. The viewer may then observe the menu, make a choice and start reading and displaying the relevant video stream. It is herein assumed that the apparatus for recording and playback is separated from the apparatus for displaying the signals, such as a TV-set. The invention is also applicable to situations and configurations of apparatuses in which both functions are united in a single apparatus.

A problem with this prior-art system resides in the relatively long start-up time, i.e. the time interval before a menu can be presented. For displaying a menu to the viewer, allowing him to make a choice of the recorded video streams, the apparatus has to access the content files to determine what video stream files are stored on the disc in order to make a table of contents which can be presented to the viewer in a menu. In optical disc systems, the time needed to jump from one location to another is rather long (up to one second). If the content files are scattered across the discs, a lot of jumps have to be made.

It is an object of the invention to provide an information carrier, an apparatus and method for recording such an information carrier, and an apparatus and method for playing back such an information carrier, allowing quicker access to the information required to display a table of contents. The time elapsing between the insertion of the information carrier and the display of the table of contents in a menu to the viewer should thus be reduced considerably.

This object is achieved by an information carrier of the type described above, wherein the information required to display a table of contents of the stream files is contained in a single content file.

This object is also achieved by such a recording apparatus which is adapted to update a single content file with information relating to the contents of the stream files when the stream files are recorded on the information carrier.

This object is also achieved by such a playback apparatus which is adapted to read a single content file before generating a display signal.

The invention also relates to such a recording method, wherein only a single file is updated during recording.

The invention also relates to a playback method, wherein initially only a single content file is read out.

As stated above, the features of the invention may be used in information carriers like DVDs. It is, however, also possible to apply the features of the invention to other storage media. It is to be noted that information carriers onto which signals can be recorded may be of the sequentially accessible type, like tapes, or of the non-sequentially accessible type, like discs. The present invention is applicable to both types of information carriers, although the advantages of the invention will be most clearly apparent from information carriers with which a considerable time is lost if the information has to be read from different locations on the medium.

The features of the present invention will be more advantageously apparent when applied in an information carrier with the files on the disc being organized in accordance with a file structure comprising:
clipinfo files containing relations about the corresponding stream file, i.e. the relation between the presentation time and the location in the stream file;
playlist files, wherein each playlist file contains information about the parts of the stream that together build up one title (playlist);
thumbnail files which contain a collection of thumbnails used in menus; and
a discinfo file with general data about the data on the disc.

The playlist file and the discinfo file in the file structure further contain a ‘maker's private data’ field. The manufacturer of the record system can write optional data into the playlist and info files.

It is expected that new technologies will lead to new disc types which can record much more information than current DVDs. This extra information may be used for recording longer movies, but it may also be used for recording movies with a higher picture quality comparable with that of High Definition TV (HDTV).

This implies that, in accordance with a preferred embodiment, the information carrier is a disc on which the information is organized in accordance with a file structure comprising clipinfo files containing relations between presentation time times and locations of the stream files, playlist files containing information relating to start and end times in the used parts of the stream files and information relating to the name and used thumbnails for the playlist or the title and discinfo files with a ‘maker's private data’ field, in which the information required to display a table of contents of the stream files is contained.

In conjunction with this embodiment, the recording apparatus of the type described above is adapted to record information on a disc with a file structure comprising: clipinf0 files containing relations between times and locations of the stream files, playlist files containing information relating to start and end times and the title name and maker's private data fields, in which the information required to display a table of contents of the stream files is contained, wherein the recording apparatus is adapted to update maker's private data fields during recording of the playlist files.

In relation therewith, the playback apparatus of the type described above is adapted to read the information from a disc with a file structure comprising clipinfo files containing relations between times and locations of the stream files, playlist files containing information relating to start and end times and the title name and maker's private data fields, in which the information required to display a table of contents of the stream files is contained, wherein the playback apparatus is adapted to read maker's private data fields and generate a display signal representing the contents of the maker's private data fields.

The invention further preferably relates to the recording method of the type described above, which method is executed on an information carrier of the type described above wherein the ‘maker's private data’ field on the disc is updated during recording.

The invention also relates to a playback method of the type described above, wherein the content information relating to the titles present on the disc from the maker's private data field is read out, from which information the display signal is generated.

The invention will be further elucidated with reference to the accompanying drawings, in which:

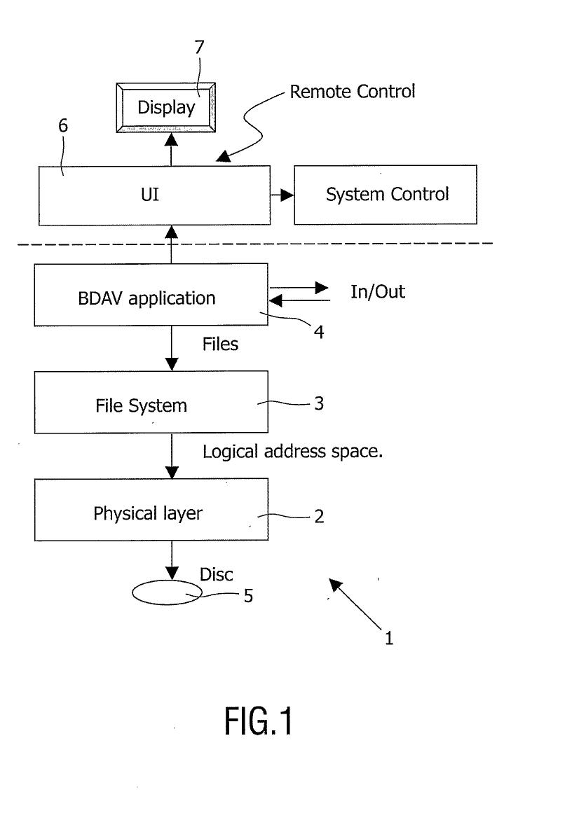

FIG. 1 is a diagram of the structure of a video player/recorder in accordance with an embodiment of the invention, adapted to play and record discs with a file structure in accordance with an embodiment of the invention; and

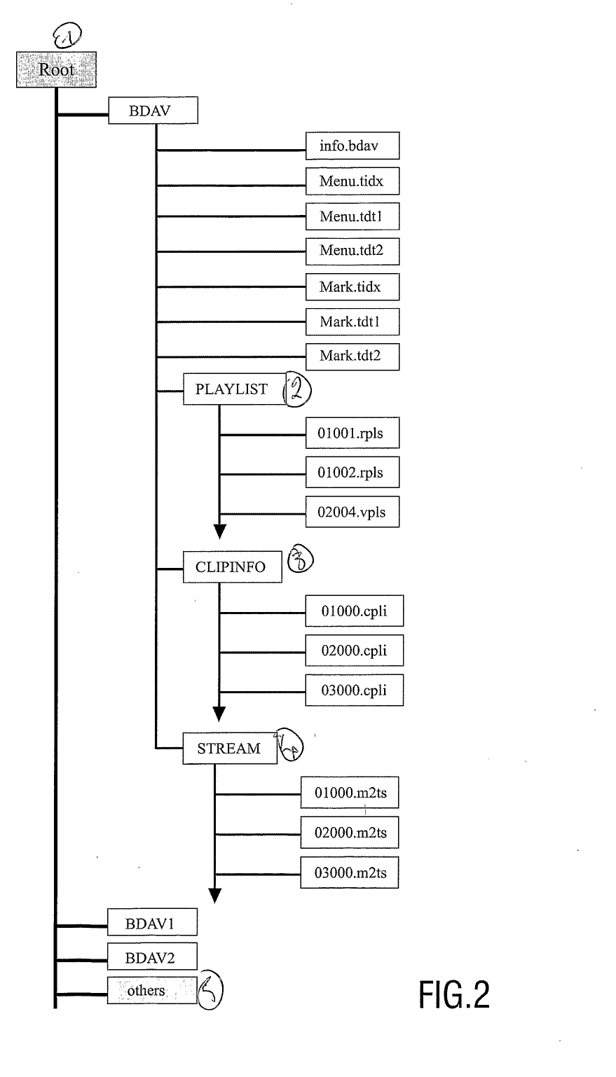

FIG. 2 is a diagram of the file structure of a disc according to the invention.

FIG. 1 is a block diagram of the functions of a video player/recorder denoted by reference numeral 1. The player 1 comprises the usual hardware, such as the disc drive, the laser read/write unit, a digital computer and a control unit 8. All of these components may be implemented in numerous ways.

The invention presupposes several aspects of the player, i.e. the physical layer 2, relating to the physical properties of the laser and associated components, the file system 3, which defines the structure and configuration of the file system of the disc, and an application 4 which is used to create and interpret the stream files and content files during recording and playback, respectively. System control and User Interface (UI) control the reading and writing functions of the player 1, together with the management of the files on the disc 5.

The system also comprises input/output means 6 for sending a signal to be displayed to a display unit 7. As stated hereinbefore, the present invention is applicable to rewritable discs only, but the players will be adapted to read video discs with a file structure to which the invention relates, and possibly also other discs.

The functions 3 and 4 are executed by the software present in the digital computer (not shown).

FIG. 2 shows the directory structure of a disc. The directory structure comprises a root directory in which a number of bdav-directories is located. Three sub-directories, denoted as ‘Playlist’, ‘Clipinfo’ and ‘Stream’ are located within each bdav-directory, just as a file info.bdav in which, inter alia, the maker's private data field and a number of files containing the thumbnails are located.

The invention relates to the maker's private data field in the info.bdav file. The information related to the contents of the playlists (Titles in the tables of contents) is located in the Playlist files and the thumbnail files. This field may comprise several pieces of information that may be recorded by the maker of a specific recording. According to the invention in the maker's private data field from the info.bdav file the relevant data for the TOC from all playlists is collected. The data needed to reconstruct a TOC is available without having to jump from one section of the disc to another.

However, the invention does not only relate to the disc onto which such a directory structure is located, but also to the method by which the content data are inserted into the maker's private data field. Such a process takes place during recording on a disc. The playlist which refers to video streams is accompanied by the relevant data, such as the title of the video string, the length of time and perhaps other data, such as the type of video. During recording of the playlist files, these data are recorded into the maker's private data field of info.bdav, in other words, these maker's private data fields are updated. It will be clear that such a process can be implemented in software, as will usually be the case with the current possibilities. This implies that the invention also relates to an apparatus which contains a memory programmed to perform such a process.

It will herein be assumed that the maker's private data fields are not only updated when new titles are being recorded on the disc, but also when titles are being erased. This will lead to a deletion of those parts of the content file that relate to the erased titles. Indeed, this prevents situations in which the viewer is presented with a choice of titles that have already been deleted. All of these processes are understood to be within the scope of ‘updating’.

The invention also relates to the process in which the advantages of the invention are beneficial, i.e. in the playback of the discs. The method according to the invention makes use of the presence of content information in the maker's private data fields so as to gain access to the contents of the disc without having to access a multitude of files scattered across the disc. When the process has accessed the contents, it can display a table of contents to the viewer by means of a usually separate unit. It is, however, also possible to apply the invention in an apparatus which is adapted to play back and display the video streams.

1. An information carrier, which is adapted to record and play back digital video information, the information carrier comprising:
stream files containing video information; and
content files containing information relating to the contents of the stream files, characterized in that the information required to display a table of contents of the stream files is contained in a single content file.

2. An information carrier as claimed in claim 1, characterized in that the information carrier is a disc on which the information is organized in accordance with a file structure comprising:
clipinfo files containing relations between presentation times and locations of the stream files;
playlist files containing information relating to start and end times and the title name; and
maker's private data fields in which the information required to display a table of contents of the stream files is contained.

3. A recording apparatus for recording digital video information on an information carrier, the recording apparatus comprising means for recording stream files on the information carrier, characterized in that the recording apparatus is adapted to update a single content file with information relating to the contents of the playlist files which are recorded on the information carrier.

4. A recording apparatus as claimed in claim 3, characterized in that the recording apparatus is adapted to record information on a disc with a file structure comprising:
clipinfo files containing relations between times and locations of the stream files;
playlist files containing information relating to start and end times and the title name; and
maker's private data fields in which the information required to display a table of contents of the stream files is contained, and
in that the recording apparatus is adapted to update maker's private data fields during recording of the playlist files on the Blu-ray disc.

5. A playback apparatus for playing back digital information from an information carrier, which playback apparatus is adapted to initially read content files from the carrier and generate a display signal representing the content files after the information carrier has been inserted into the playback apparatus, characterized in that the apparatus is adapted to read a single content file before generating a display signal.

6. A playback apparatus as claimed in claim 5, characterized in that the playback apparatus is adapted to play back information from a disc with a file structure comprising:
clipinfo files containing relations between times and locations of the stream files;
playlist files containing information relating to start and end times and the title name; and
maker's private data fields, in which the information required to display a table of contents of the stream files is contained; and
in that the playback apparatus is adapted to read maker's private data fields and generate a display signal representing the contents of the maker's private data field.

7. A playback apparatus as claimed in claim 6, characterized in that, after generating a signal representing the contents of the maker's private data field, the apparatus is adapted to read out thumbnail files and generate a signal representing thumbnails relating to the contents of the maker's private data fields.

8. A recording apparatus as claimed in claim 3, characterized in that it is united with a playback apparatus for playing back digital information from an information carrier, which playback apparatus is adapted to initially read content files from the carrier and generate a display signal representing the content files after the information carrier has been inserted into the playback apparatus, characterized in that the apparatus is adapted to read a single content file before generating a display signal.

9. A recording method for recording digital information representing a video signal on an information carrier, the method comprising the steps of recording video stream files containing video information on the information carrier, and updating content files containing information relating to the contents of the stream files, characterized in that only a single file is updated during recording.

10. A recording method as claimed in claim 8, characterized in that the method is executed on an information carrier with a file structure comprising:
clipinfo files containing relations between times and locations of the stream files;
playlist files containing information relating to start and end times and the title name; and
maker's private data fields, in which the information required to display a table of contents of the stream files is contained; and
in that the maker's private data field on the Blu-ray disc is updated during recording.

11. A playback method for playing back digital information representing a video signal from an information carrier, the method comprising the steps of playing back video stream files containing video information from a video carrier, reading out content files present on the information carrier and generating a display signal representing the information in the content files, characterized in that initially the content files are read out.

12. A playback method as claimed in claim 11, characterized in that the information carrier has a file structure comprising:
clipinfo files containing relations between times and locations of the stream files;
playlist files containing information relating to start and end times and the title name; and
maker's private data fields, in which the information required to display a table of contents of the stream files is contained; and
in that initially the content information relating to the video stream files present on the disc from the maker's private data field is read out, from which information the display signal is generated.

13. A playback method as claimed in claim 12, characterized in that, after reading out, the maker's private data field containing thumbnails are read out, and in that, after generating the display signal, a signal containing the information of thumbnail files present on the disc is generated.
